(19) United States
(12) Patent Application Publication
(10) Pub. No.: US 2024/0157476 A1
(43) Pub. Date: May 16, 2024

(54) LASER PROCESSING APPARATUS AND PROCESSING METHOD

(71) Applicant: DISCO CORPORATION, Tokyo (JP)

(72) Inventors: Haruki KAMIYAMA, Tokyo (JP); Toshiyuki AKISHIBA, Tokyo (JP)

(21) Appl. No.: 18/499,723

(22) Filed: Nov. 1, 2023

(30) Foreign Application Priority Data
Nov. 11, 2022 (JP) 2022-181103

(51) Int. Cl. B23K 26/06; B23K 26/14

(52) U.S. Cl. CPC B23K 26/0648; B23K 26/1462

(57) ABSTRACT

A laser processing apparatus includes a holding unit for holding a workpiece thereon, a laser oscillator for emitting a laser beam to be applied to the workpiece held on the holding unit, a condensing lens for focusing the laser beam emitted from the laser oscillator to the workpiece, a lens holder housing the condensing lens therein, a cover glass disposed between the condensing lens and the holding unit for protecting the condensing lens from debris produced from the workpiece when the workpiece is processed by the laser beam, and a cover glass holder housing the cover glass and attached to the lens holder. The cover glass holder is rotatably mounted on the lens holder for rotation about a central axis spaced eccentrically from an optical axis of the condensing lens and parallel to the optical axis.

### BACKGROUND OF THE INVENTION

### Field of the Invention

The present invention relates to a laser processing apparatus and a processing method.

### Description of the Related Art

When a laser beam emitted from a condensing lens is applied to a workpiece to perform an ablating process on the workpiece, the workpiece produces debris. If the debris produced from the workpiece in the ablating process is deposited on the condensing lens, then the deposited debris tends to obstruct the emission of the laser beam from the condensing lens. There has been proposed a laser processing apparatus including a suction unit for drawing debris under suction and a debris trapping chamber for trapping the drawn debris (see, for example, JP 2017-035714A).

There has also been devised a laser processing apparatus that applies a laser beam to a workpiece to form peel-off initiating points in the workpiece (see, for example, JP 2016-111143A).

### SUMMARY OF THE INVENTION

The laser processing apparatus disclosed in JP 2017-035714A requires a condensing lens having a large numerical aperture for constricting a laser beam spot formed by the condensing lens. However, since a condensing lens having a large numerical aperture has a small depth of focus, it is difficult to secure a space large enough to accommodate the debris trapping chamber etc. below the condensing lens.

The laser processing apparatus disclosed in JP 2016-111143A is problematic in that swarf such as debris produced from a workpiece when a laser beam emitted from a condensing lens is applied to the workpiece is likely to be deposited on the condensing lens or to cause damage to the condensing lens.

There have been demands that the laser processing apparatus disclosed in JP 2017-035714A and JP 2016-111143A that have heretofore been used in the art should be able to continue processing a workpiece with a laser beam without removing debris deposited on a laser beam applying unit.

It is therefore an object of the present invention to provide a laser processing apparatus and a processing method that make it possible to continue processing a workpiece with a laser beam without removing debris produced from the workpiece when the workpiece is processed by the laser beam and deposited on a laser beam applying unit.

In accordance with an aspect of the present invention, there is provided a laser processing apparatus including a holding unit for holding a workpiece thereon, a laser oscillator for emitting a laser beam to be applied to the workpiece held on the holding unit, a condensing lens for focusing the laser beam emitted from the laser oscillator to the workpiece, a lens holder housing the condensing lens therein, a cover glass disposed between the condensing lens and the holding unit for protecting the condensing lens from foreign matter produced from the workpiece when the workpiece is processed by the laser beam, and a cover glass holder housing the cover glass and attached to the lens holder, in which the cover glass holder is rotatably mounted on the lens holder for rotation about a central axis spaced eccentrically from an optical axis of the condensing lens and parallel to the optical axis.

Preferably, the laser processing apparatus further includes a gas ejection nozzle for ejecting a gas along a surface of the cover glass that faces the workpiece held on the holding unit.

In accordance with another aspect of the present invention, there is provided a processing method of processing a workpiece with a laser processing apparatus including a holding unit for holding a workpiece thereon, a laser oscillator for emitting a laser beam to be applied to the workpiece held on the holding unit, a condensing lens for focusing the laser beam emitted from the laser oscillator to the workpiece, a lens holder housing the condensing lens therein, a cover glass disposed between the condensing lens and the holding unit for protecting the condensing lens from foreign matter produced from the workpiece when the workpiece is processed by the laser beam, and a cover glass holder housing the cover glass and attached to the lens holder, the processing method including a cover glass turning step of turning the cover glass about a central axis thereof at a predetermined timing, and after the cover glass turning step, a processing step of focusing the laser beam emitted from the laser oscillator with the focusing lens and applying the focused laser beam to the workpiece held on the holding unit, thereby processing the workpiece with the laser beam.

The present invention is advantageous in that the workpiece can continuously be processed by the laser beam without removing debris produced from the workpiece when the workpiece is processed by the laser beam and deposited on the laser beam applying unit.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view illustrating a structural example of a laser processing apparatus according to an embodiment of the present invention;

FIG. 2 is a perspective view of a workpiece to be processed by the laser processing apparatus according to the embodiment illustrated in FIG. 1;

FIG. 3 is a side elevational view of the workpiece illustrated in FIG. 2;

FIG. 4 is a perspective view of a wafer peeled off from the workpiece illustrated in FIG. 2;

FIG. 5 is a schematic side elevational view, partly in block form, of a laser beam applying unit of the laser processing apparatus illustrated in FIG. 1;

FIG. 6 is a perspective view illustrating the appearance of a lens holder of the laser beam applying unit illustrated in FIG. 5;

FIG. 7 is another perspective view illustrating the appearance of the lens holder illustrated in FIG. 6;

FIG. 8 is a fragmentary cross-sectional view taken along line VIII-VIII of FIG. 6;

FIG. 9 is a fragmentary cross-sectional view taken along line IX-IX of FIG. 7;

FIG. 10 is a bottom view of the lens holder illustrated in FIG. 6;

FIG. 11 is a fragmentary perspective view of a lower end portion of the lens holder illustrated in FIG. 6;

FIG. 12 is a perspective view of a cover assembly of the laser beam applying unit illustrated in FIG. 5;

FIG. 13 is a cross-sectional view taken along line XIII-XIII of FIG. 12;

FIG. 14 is an exploded perspective view of the cover assembly illustrated in FIG. 12;

FIG. 15 is a cross-sectional view taken along line XV-XV of FIG. 14;

FIG. 16 is an enlarged cross-sectional view of a portion XVI illustrated in FIG. 13;

FIG. 17 is an enlarged fragmentary perspective view of an area where the cover assembly illustrated in FIG. 12 is fixed to the lower end portion of the lens holder;

FIG. 18 is a perspective view of an eccentric pin by which the cover assembly illustrated in FIG. 12 is fixed to the lower end portion of the lens holder;

FIG. 19 is a plan view of the eccentric pin as viewed from direction XIX illustrated in FIG. 18;

FIG. 20 is a side elevational view of the eccentric pin as viewed from direction XX illustrated in FIG. 19;

FIG. 21 is a front elevational view of the eccentric pin as viewed from direction XXI illustrated in FIG. 20;

FIG. 22 is a front elevational view illustrating the manner in which the eccentric pin illustrated in FIG. 18 fixes the cover assembly to the lower end portion of the lens holder in a nominal position;

FIG. 23 is a front elevational view illustrating the manner in which the eccentric pin illustrated in FIG. 18 fixes the cover assembly to the lower end portion of the lens holder in a position where the cover assembly is spaced downwardly from the nominal position illustrated in FIG. 22;

FIG. 24 is a front elevational view illustrating the manner in which the eccentric pin illustrated in FIG. 18 fixes the cover assembly to the lower end portion of the lens holder in a position where the cover assembly is spaced upwardly from the nominal position illustrated in FIG. 22;

FIG. 25 is a flowchart of the processing sequence of a processing method according to the embodiment; and

FIG. 26 is a perspective view schematically illustrating a processing step of the processing method illustrated in FIG. 25.

### DETAILED DESCRIPTION OF THE PREFERRED EMBODIMENT

A preferred embodiment of the present invention will be described in detail hereinbelow with reference to the accompanying drawings. The present invention is not limited to the details of the embodiment described below. The components described below cover those which could easily be anticipated by those skilled in the art and those which are essentially identical to those described below. Furthermore, the arrangements described below can be combined in appropriate manners. Various omissions, replacements, or changes of the arrangements may be made without departing from the scope of the present invention. In the description below, those components that are identical to each other are denoted by identical reference signs.

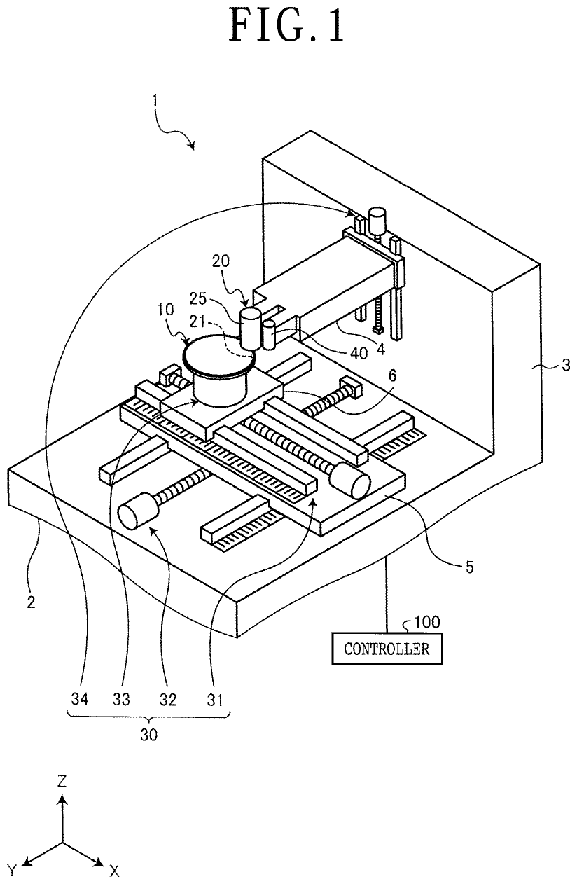

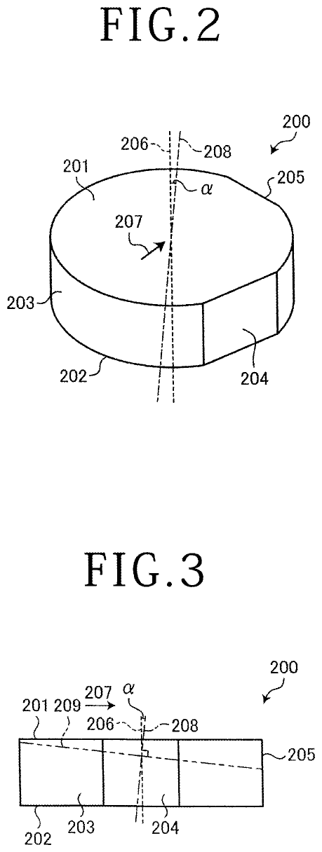

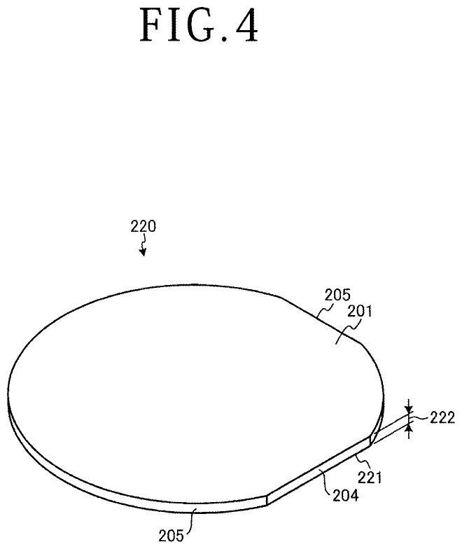

A laser processing apparatus according to the present embodiment will be described below. FIG. 1 illustrates in perspective a structural example of a laser processing apparatus according to the present embodiment. FIG. 2 illustrates in perspective a workpiece to be processed by the laser processing apparatus according to the present embodiment. FIG. 3 illustrates in side elevation the workpiece illustrated in FIG. 2. FIG. 4 illustrates in perspective view a wafer peeled off from the workpiece illustrated in FIG. 2. The laser processing apparatus, denoted by 1 in FIG. 1, refers to a processing apparatus for applying a laser beam 21 to the workpiece, denoted by 200 in FIGS. 2 and 3.

According to the present embodiment, the workpiece 200 to be processed by the laser processing apparatus 1 represents an ingot that has a cylindrical shape as a whole and that is made of silicon carbide (SiC). According to the present embodiment, the workpiece 200 is a hexagonal monocrystalline SiC ingot. According to the present invention, however, the workpiece 200 may be made of germanium (Ge), gallium arsenide (GaAs), gallium nitride (GaN), or silicon (Si).

As illustrated in FIGS. 2 and 3, the workpiece 200 has a first surface 201 having a circular shape, a second surface 202 having a circular shape on a side opposite the first surface 201, and a circumferential surface 203 extending between and joined to the outer edge of the first surface 201 and the outer edge of the second surface 202. The workpiece 200 has on the circumferential surface 203 a first straight orientation flat 204 representing the crystal orientation of the workpiece 200 and a second straight orientation flat 205 extending perpendicularly to the first straight orientation flat 204. The first straight orientation flat 204 is longer than the second straight orientation flat 205.

After the first surface 201 of the workpiece 200 has been coarsely and then finishingly ground by a grinding apparatus, not illustrated, the first surface 201 of the workpiece 200 is polished to a mirror finish by a polishing apparatus, not illustrated. The workpiece 200 has a c-axis 208 inclined an off-angle α to a line 206 normal to the first surface 201 in an inclining direction 207 toward the second orientation flat 205 and a c-plane 209 extending perpendicularly to the c-axis 208. The c-plane 209 is inclined the off-angle α to the first surface 201. The inclining direction 207 in which the c-axis 208 is inclined to the line 206 extends perpendicularly to the directions in which the second orientation flat 205 extends, and extends parallel to the first orientation flat 204. The c-plane 209 is established as countless planes in the workpiece 200 at a molecular level of the workpiece 200. According to the present embodiment, the off-angle α is set to 1°, 4°, or 6°. According to the present invention, however, the off-angle α may be set freely to an angle in the range from 1° to 6°, for example, in the fabrication of the workpiece 200.

A flat piece of the workpiece 200 that includes the first surface 201 is peeled off into a slice to be fabricated into a wafer 220 illustrated in FIG. 4. As successive slices are peeled off from the workpiece 200, the workpiece 200 is progressively reduced in thickness. An end surface of the workpiece 200 from which a flat piece has been peeled off is ground and polished into a new first surface 201 having a mirror finish. Then, a next slice to be fabricated into a wafer 220 is peeled off from the workpiece 200. The peeling process continues until a necessary number of slices have been peeled off.

The wafer 220 illustrated in FIG. 4 is fabricated from a flat piece including the first surface 201 that has been peeled off from the workpiece 200. Therefore, the wafer 220 includes the first surface 201 and a peeled-off surface 221 that has been peeled off from the workpiece 200, opposite the first surface 201. Consequently, the wafer 220 is of the same material as the workpiece 200. The peeled-off surface 221 is coarsely and then finishingly ground by a grinding apparatus, not illustrated, and thereafter polished to a mirror finish by a polishing apparatus. Thereafter, a plurality of devices are constructed in a grid of respective areas that are demarcated in the polished peeled-off surface 221 by a plurality of projected dicing lines.

According to the present embodiment, the devices include metal-oxide-semiconductor field-effect transistors (MOSFETs), microelectromechanical systems (MEMSs), or Schottky barrier diodes (SBDs). According to the present invention, however, the devices are not limited to MOSFETs, MEMSs, and SBDs. Those parts of the wafer 220 that are identical to those of the workpiece 200 are denoted by identical reference signs and will be omitted from detailed description.

The laser processing apparatus 1 illustrated in FIG. 1 applies the laser beam 21, which is a pulsed laser beam having a wavelength transmittable through the workpiece 200, to the workpiece 200 to process the workpiece 200 with the pulsed laser beam 21. As illustrated in FIG. 1, the laser processing apparatus 1 includes a holding unit 10 for holding the workpiece 200, a laser beam applying unit 20, a moving assembly 30, an image capturing unit 40, and a controller 100. The laser processing apparatus 1 is illustrated in reference to a three-dimensional XYZ coordinate system having an X-axis represented by the arrow X, a Y-axis represented by the arrow Y, and a Z-axis represented by the arrow Z in FIG. 1. The X-axis and the Y-axis extend horizontally and perpendicularly to each other, and the Z-axis extends vertically and perpendicularly to the X-axis and the Y-axis.

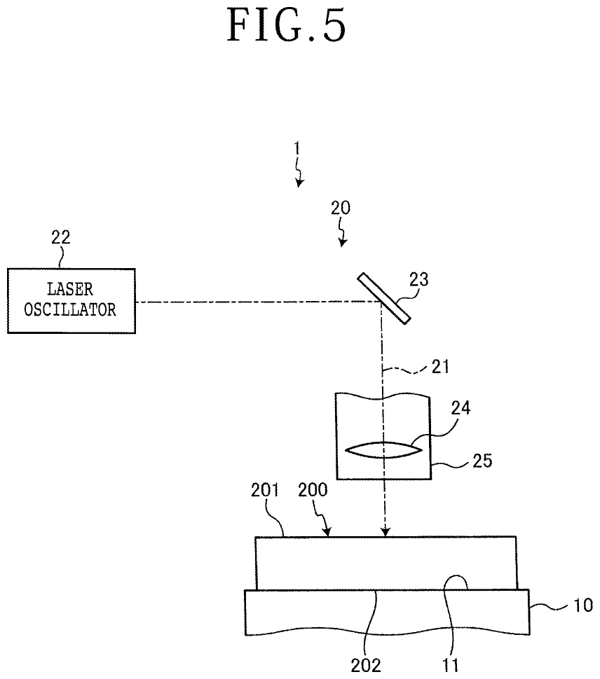

The holding unit 10 holds the workpiece 200 on a holding surface 11 (see FIG. 5) thereof that lies horizontally. The holding surface 11 is made of porous ceramic or the like and is of a disk shape. The holding surface 11 is fluidly connected to a vacuum suction source, not illustrated, through a suction channel, not illustrated. The holding unit 10 holds the workpiece 200 under suction on the holding surface 11 when the holding surface 11 is evacuated by the vacuum suction source.

The holding unit 10 is rotatable about its central axis that is perpendicular to the holding surface 11 and parallel to the Z-axis by a rotating unit 33 of the moving assembly 30. The holding unit 10 together with the rotating unit 33 is movable along the X-axis by an X-axis moving unit 31 of the moving assembly 30 and also movable along the Y-axis by a Y-axis moving unit 32 of the moving assembly 30. The holding unit 10 is movable by the moving assembly 30 between a processing region below the laser beam applying unit 20 and a loading/unloading region spaced along the X-axis from the processing region. In the processing region, the workpiece 200 held on the holding unit 10 is processed by the laser beam 21. In the loading/unloading region, the workpiece 200 is loaded onto and unloaded from the holding unit 10.

The moving assembly 30 moves the holding unit 10 and the focused spot of the laser beam 21 that is applied by the laser beam applying unit 20 relatively to each other along the X-axis, the Y-axis, and about the central axis parallel to the Z-axis. As described above, the X-axis and the Y-axis extend perpendicularly to each other and horizontally parallel to the holding surface 11, and the Z-axis extends perpendicularly to both the X-axis and the Y-axis.

The moving assembly 30 includes the X-axis moving unit 31 that functions as a processing feed unit for moving the holding unit 10 along the X-axis, the Y-axis moving unit 32 that functions as an indexing feed unit for moving the holding unit 10 along the Y-axis, the rotating unit 33 that rotates the holding unit 10 about the central axis parallel to the Z-axis, and a Z-axis moving unit 34 for moving the focused spot of the laser beam 21 that is applied by the laser beam applying unit 20 along the Z-axis.

Specifically, the Y-axis moving unit 32 functioning as the indexing feed unit moves the holding unit 10 and the focused spot of the laser beam 21 that is applied by the laser beam applying unit 20 relatively to each other along the Y-axis. According to the present embodiment, the Y-axis moving unit 32 is mounted on an apparatus base 2 of the laser processing apparatus 1. The Y-axis moving unit 32 supports a first movable plate 5 that supports the X-axis moving unit 31 such that the first movable plate 5 is movable along the Y-axis.

Specifically, the X-axis moving unit 31 functioning as the processing feed unit moves the holding unit 10 and the focused spot of the laser beam 21 that is applied by the laser beam applying unit 20 relatively to each other along the X-axis. According to the present embodiment, the X-axis moving unit 31 is mounted on the movable plate 5. The X-axis moving unit 31 supports a second movable plate 6 that supports the rotating unit 33 such that the second movable plate 6 is movable along the X-axis. The second movable plate 6 supports the rotating unit 33 and the holding unit 10. The rotating unit 33 supports the holding unit 10.

Specifically, the Z-axis moving unit 34 functions as a feed unit that moves the holding unit 10 and the focused spot of the laser beam 21 that is applied by the laser beam applying unit 20 relatively to each other along the Z-axis. The Z-axis moving unit 34 is mounted on an upstanding wall 3 erected on the apparatus base 2. The Z-axis moving unit 34 supports a support arm 4 such that the support arm 4 is movable along the Z-axis. The support arm 4 supports, on a distal end thereof, a portion of the laser beam applying unit 20 that includes a condensing lens 24 (see FIG. 5) to be described later.

The X-axis moving unit 31 includes a known ball screw rotatable about its central axis parallel to the X-axis for moving the second movable plate 6 along the X-axis when rotated about the central axis, a known stepping motor for rotating the ball screw about the central axis when energized, and a pair of guide rails on which the second movable plate 6 is slidably supported for movement along the X-axis. The Y-axis moving unit 32 includes a known ball screw rotatable about its central axis parallel to the Y-axis for moving the first movable plate 5 along the Y-axis when rotated about the central axis, a known stepping motor for rotating the ball screw about the central axis when energized, and a pair of guide rails on which the first movable plate 5 is slidably supported for movement along the Y-axis. The Z-axis moving unit 34 includes a known ball screw rotatable about its central axis parallel to the Z-axis for moving the support arm 4 along the Z-axis when rotated about the central axis, a known stepping motor for rotating the ball screw about the central axis when energized, and a pair of guide rails on which the support arm 4 is slidably supported for movement along the Z-axis. The rotating unit 33 includes an electric motor for rotating the holding unit 10 about its central axis when energized.

The laser processing apparatus 1 includes an X-axis position detecting unit, not illustrated, for detecting the position of the holding unit 10 along the X-axis, a Y-axis position detecting unit, not illustrated, for detecting the position of the holding unit 10 along the Y-axis, and a Z-axis position detecting unit, not illustrated, for detecting the position, i.e., the height, of the condensing lens 24 (see FIG. 5) of the laser beam applying unit 20 along the Z-axis. The X-axis position detecting unit, the Y-axis position detecting unit, and the Z-axis position detecting unit output respective detected positions to the controller 100. According to the present embodiment, the positions of the holding unit 10 respectively along the X-axis and the Y-axis and the position of the condensing lens 24 along the Z-axis are defined according to their distances along the X-axis, the Y-axis, and the Z-axis from predetermined reference positions, not illustrated.

The laser beam applying unit 20 will be described below. FIG. 5 schematically illustrates in side elevation, partly in block form, of the laser beam applying unit 20 of the laser processing apparatus 1 illustrated in FIG. 1.

The laser beam applying unit 20 functions as laser beam applying means for focusing and applying the pulsed laser beam 21 to the workpiece 200 held on the holding surface 11 of the holding unit 10. According to the present embodiment, as illustrated in FIG. 1, the portion referred above of the laser beam applying unit 20 that includes the condensing lens 24 is supported on the distal end of the support arm 4 that is supported on the Z-axis moving unit 34 on the upstanding wall 3 such that the support arm 4 is movable along the Z-axis by the Z-axis moving unit 34.

The laser beam applying unit 20 applies the pulsed laser beam 21 whose wavelength is transmittable through the workpiece 200 on the holding unit 10 to the workpiece 200. As illustrated in FIG. 5, the laser beam applying unit 20 includes a laser oscillator 22 for oscillating pulsed laser to be applied to the workpiece 200 on the holding unit 10 and emitting the laser beam 21, a mirror 23 for reflecting the laser beam 21 emitted from the laser oscillator 22, the condensing lens 24 that functions as a beam condenser for focusing the laser beam 21 emitted from the laser oscillator 22 and reflected by the mirror 23 onto the workpiece 200, and a lens holder 25 that houses at least the condensing lens 24 therein.

The condensing lens 24 is disposed in a position that faces the holding surface 11 of the holding unit 10 along the Z-axis. The condensing lens 24 functions as a focusing optical element for focusing and applying the pulsed laser beam 21 to the workpiece 200 held on the holding unit 10. The condensing lens 24 transmits the laser beam 21 emitted from the laser oscillator 22 and reflected by the mirror 23 therethrough and focuses the laser beam 21 onto the workpiece 200 held on the holding unit 10. According to the present embodiment, the condensing lens 24 focuses the laser beam 21 within the workpiece 200 held on the holding surface 11 of the holding unit 10. The lens holder 25 is supported on the distal end of the support arm 4. Structural details of the lens holder 25 will be described later.

The laser beam applying unit 20 processes the workpiece 200 held on the holding unit 10 with the laser beam 21 whose wavelength is transmittable through the workpiece 200 by applying the laser beam 21 to the workpiece 200. According to the present embodiment, the wavelength of the laser beam 21 is of a value in the infrared range, e.g., 1064 nm.

The image capturing unit 40 captures an image of the workpiece 200 on the holding unit 10. The image capturing unit 40 includes an image sensor such as a charge-coupled-device (CCD) image sensor or a complementary-MOS (CMOS) image sensor that includes an objective lens facing the workpiece 200 whose image is to be captured along the Z-axis. According to the present embodiment, as illustrated in FIG. 1, the image capturing unit 40 is mounted on the distal end of the support arm 4 at a position where the objective lens is disposed alongside of the condensing lens 24 along the X-axis.

The image capturing unit 40 acquires an image captured by the image sensor and outputs the acquired image to the controller 100. The image capturing unit 40 also acquires an image captured by the image sensor of the workpiece 200 on the holding surface 11 for use in an alignment process for aligning the workpiece 200 and the laser applying unit 20 with each other on the basis of the captured image.

The controller 100 controls the components described above of the laser processing apparatus 1 to enable the laser processing apparatus 1 to perform a processing operation on the workpiece 200. The controller 100 includes a computer including a processing device having a microprocessor such as a central processing unit (CPU), a storage device having a memory such as a read only memory (ROM) or a random access memory (RAM), and an input/output interface device. The processing device performs the functions of the controller 100 by carrying out processing sequences according to computer programs stored in the storage device and generating and outputting control signals for controlling the laser processing apparatus 1 via the input/output interface device to the components of the laser processing apparatus 1.

The laser processing apparatus 1 includes a display unit as display means such as a liquid crystal display device for displaying, for example, states and images of the processing operation, and an input unit as input means that the user uses to enter processing conditions etc. The display unit and the input unit are electrically connected to the controller 100. According to the present embodiment, the input unit is provided as a touch panel incorporated in the display unit.

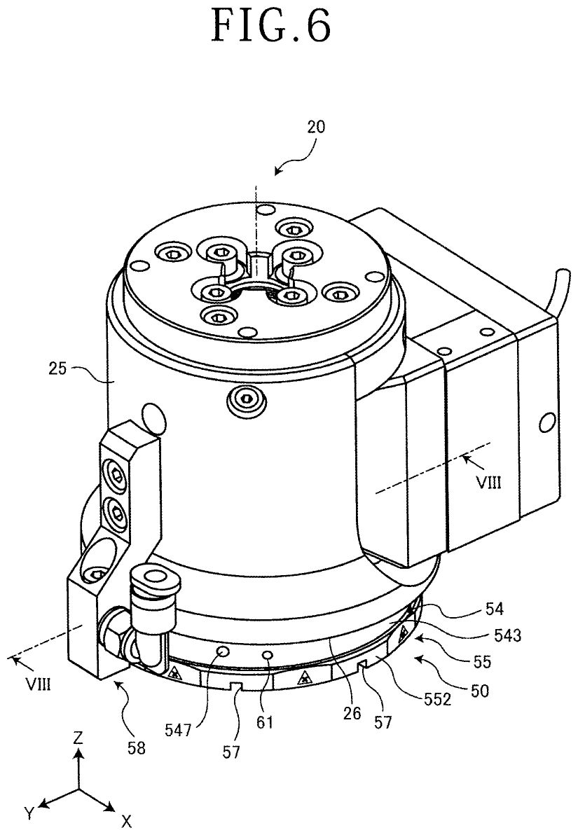

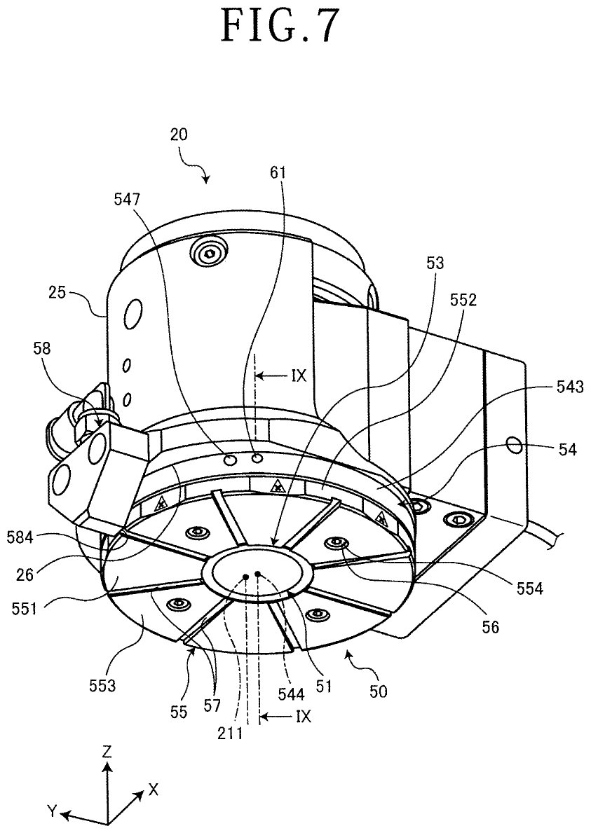

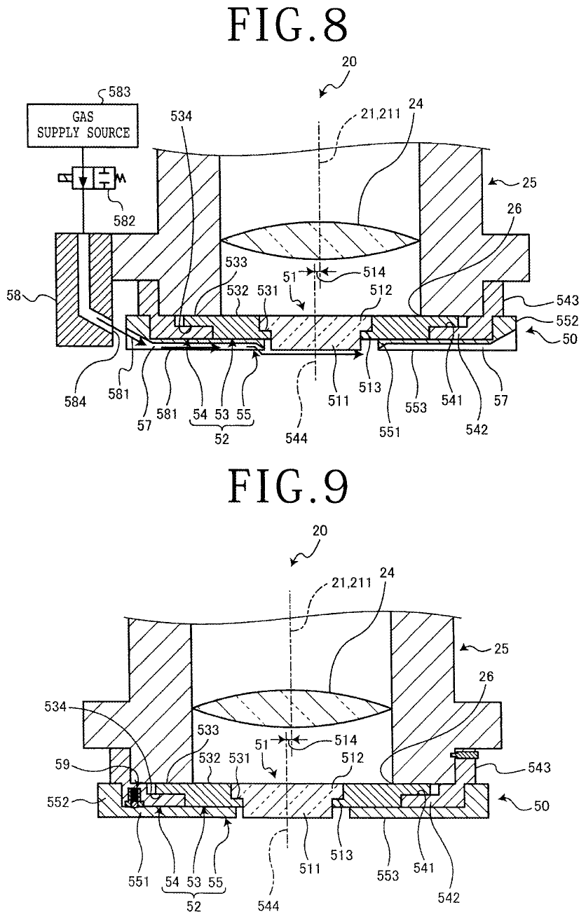

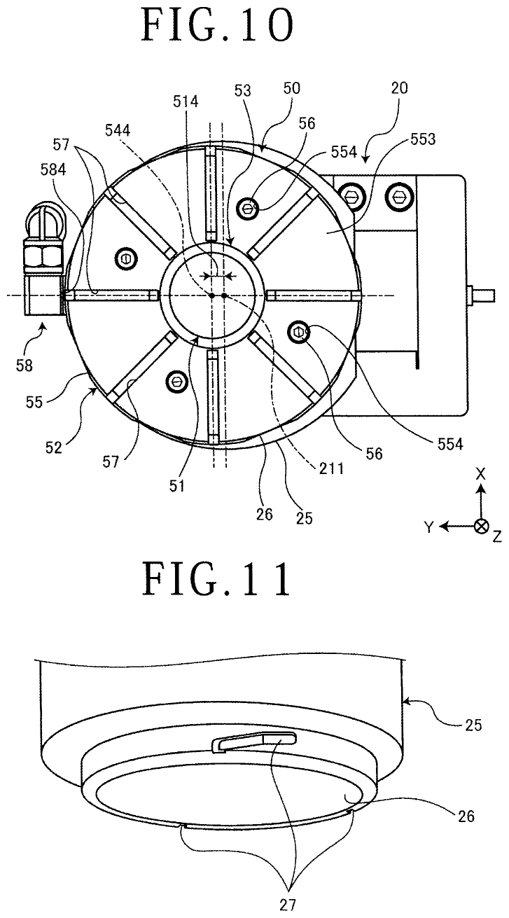

The structural details of the lens holder 25 will be described below. FIG. 6 illustrates in perspective the appearance of the lens holder 25 of the laser beam applying unit 20 illustrated in FIG. 5. FIG. 7 illustrates in another perspective the appearance of the lens holder 25 illustrated in FIG. 6. FIG. 8 illustrates in fragmentary cross section the parts taken along line VIII-VIII of FIG. 6. FIG. 9 illustrates in fragmentary cross section parts taken along line IX-IX of FIG. 7. FIG. 10 illustrates in bottom view the lens holder 25 illustrated in FIG. 6. FIG. 11 illustrates in fragmentary perspective a lower end portion of the lens holder 25 illustrated in FIG. 6.

The laser beam applying unit 20 includes, in addition to the laser oscillator 22, the mirror 23, the condensing lens 24, and the lens holder 25, a cover assembly 50 closing a lower opening 26 of the lens holder 25 and an air ejection nozzle 58 as illustrated in FIGS. 6, 7, 8, 9, and 10. The lens holder 25 is of a hollow cylindrical shape with its central axis parallel to the Z-axis and has an upper end closed and a lower end open through the lower opening 26. As illustrated in FIGS. 8 and 9, the lens holder 25 houses the condensing lens 24 therein and has the lower opening 26 closed by the cover assembly 50 (see FIGS. 8, 9, and 10).

As illustrated in FIG. 11, the lens holder 25 has a lower end portion with a plurality of (three in the present embodiment) attachment grooves 27 defined in an outer circumferential surface thereof for attaching the cover assembly 50 to the lower end portion. Each of the attachment groove 27 is defined as an elongate concavity in the outer circumferential surface of the lower end portion of the lens holder 25, and has an end that is open at a lower end face of the lens holder 25 and extends in a circumferential direction from the open end to an opposite closed end thereof. Each of the attachment grooves 27 is inclined to both the circumferential direction and the axial direction of the lens holder 25 such that it is oriented progressively upwardly from the open end toward the opposite closed end. According to the present embodiment, the attachment grooves 27 are angularly spaced at equal intervals circumferentially around the lens holder 25.

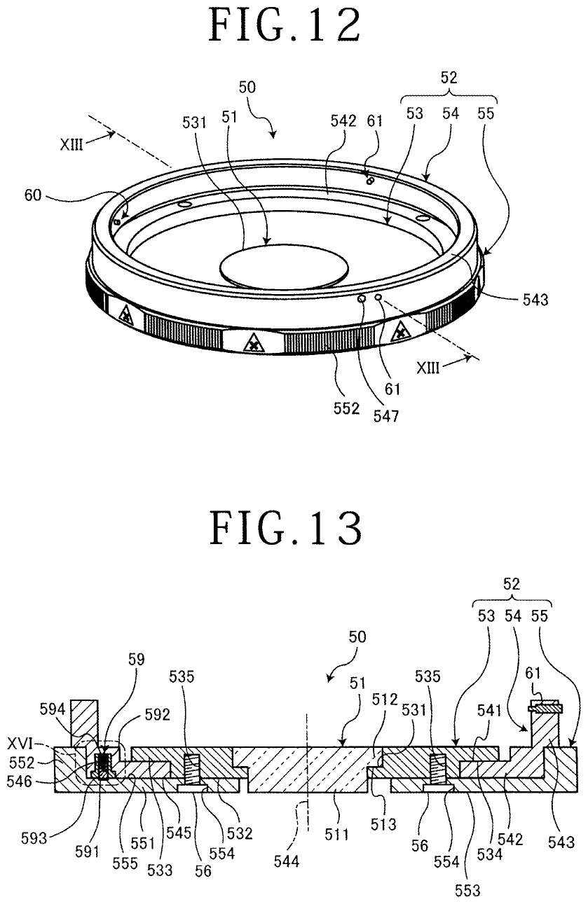

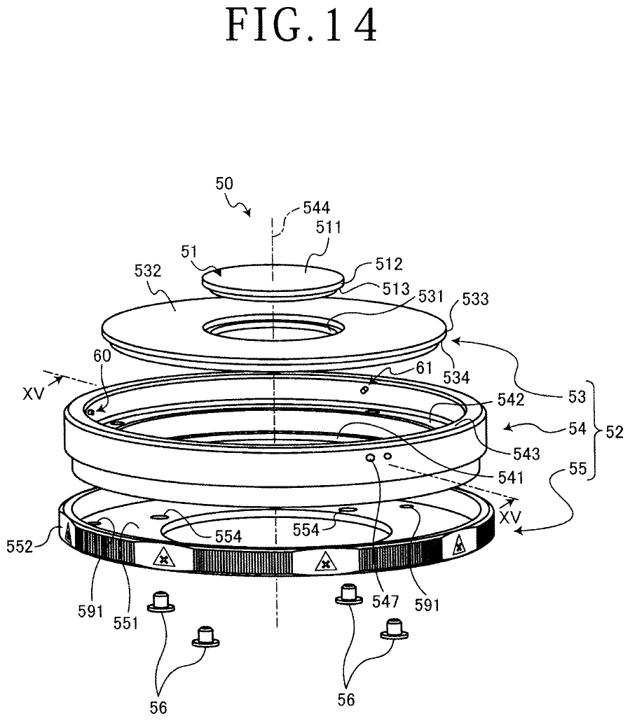

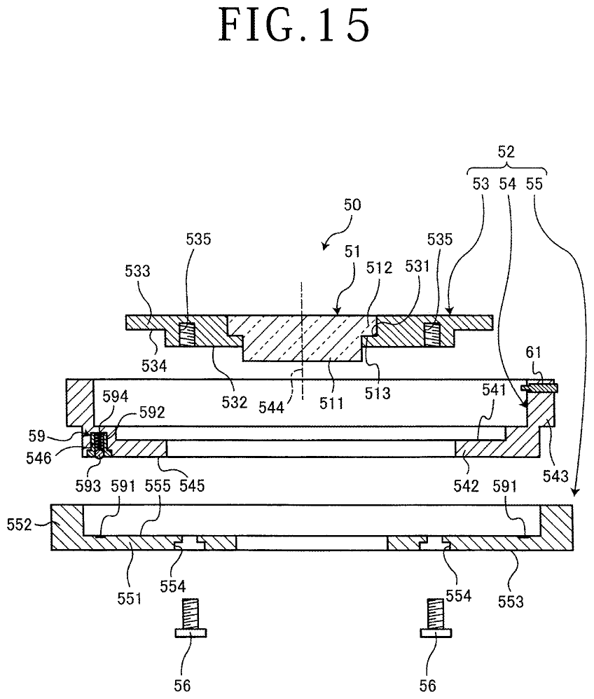

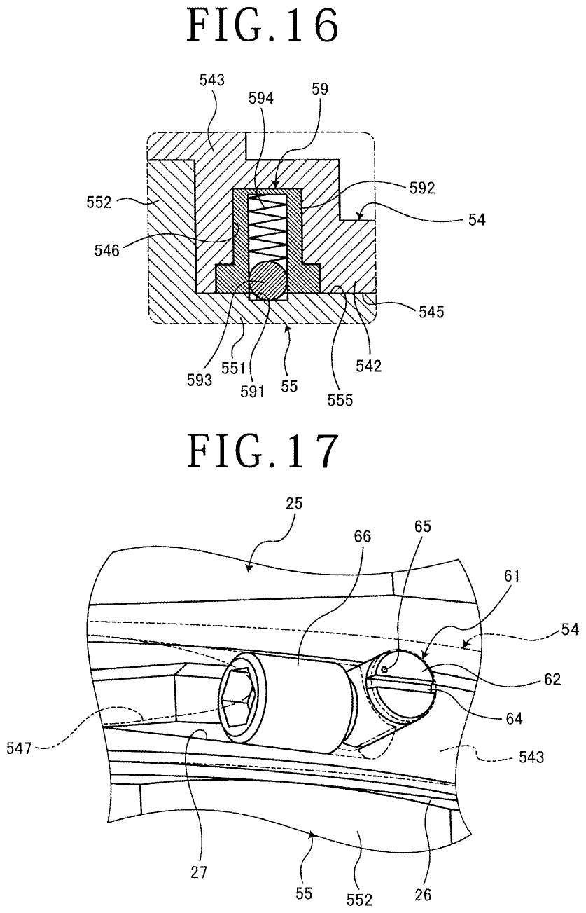

The cover assembly 50 will be described in detail below. FIG. 12 illustrates in perspective the cover assembly 50 of the laser beam applying unit 20 illustrated in FIG. 5. FIG. 13 illustrates in cross section the parts taken along line XIII-XIII of FIG. 12. FIG. 14 illustrates in exploded perspective the cover assembly 50 illustrated in FIG. 12. FIG. 15 illustrates in cross section the parts taken along line XV-XV of FIG. 14. FIG. 16 illustrates in enlarged cross section a portion XVI illustrated in FIG. 13.

The cover assembly 50 allows the laser beam 21 that has been focused by the condensing lens 24 to pass therethrough. The cover assembly 50 closes the lower opening 26 of the lens holder 25 and protects the condensing lens 24 in order to prevent debris produced as foreign matter from the workpiece 200 as it is processed by the laser beam 21 applied thereto, from being deposited on the condensing lens 24. As illustrated in FIGS. 12, 13, 14, and 15, the cover assembly 50 includes a cover glass 51 and a cover glass holder 52.

The cover glass 51 is attached to the lens holder 25 and disposed between the condensing lens 24 and the holding unit 10 for protecting the condensing lens 24 from debris produced from the workpiece 200 as it is processed by the laser beam 21 applied thereto. The cover glass 51 is made of a material through which the laser beam 21 can be transmitted and is of a circular plate shape.

As illustrated in FIGS. 13, 14, and 15, the cover glass 51 is of an integral structure including a circular plate 511 having a constant thickness and an annular rim 512 joined to an outer edge of the circular plate 511 and smaller in thickness than the circular plate 511. The circular plate 511 and the annular rim 512 of the cover glass 51 mounted on the lens holder 25 have respective axial end faces lying flush with each other and facing the condensing lens 24 and other respective axial end faces facing the holding unit 10 and axially offset from each other, providing a step 513 therebetween. Specifically, the step 513 is defined by the other axial end face of the annular rim 512 that is axially spaced from the other axial end face of the circular plate 511.

The laser beam 21 that is focused by the condensing lens 24 is transmitted through the cover glass 51 mounted on the lens holder 25. According to the present embodiment, the laser beam 21 that is transmitted through the cover glass 51 has its optical axis 211 radially spaced from the center of the cover glass 51 by a predetermined distance 514 (see FIG. 10, for example). According to the present embodiment, the distance 514 is 2.5 mm, for example, and the optical axis 211 of the laser beam 21 is aligned with the optical axis of the condensing lens 24.

With the cover glass 51 mounted on the lens holder 25, therefore, the optical axis 211 of the condensing lens 24 and the laser beam 21 is radially spaced from the center of the cover glass 51 by the predetermined distance 514. The fact that the optical axis 211 of the condensing lens 24 and the laser beam 21 is radially spaced from the center of the cover glass 51 by the predetermined distance 514 is equivalent to the fact that the center of the cover glass 51 is positioned out of alignment with the optical axis 211, i.e., eccentrically or off-center with respect to the optical axis 211. According to the present embodiment, the cover glass 51 have both axial surfaces coated with an anti-reflection film, not illustrated.

The cover glass holder 52 accommodates the cover glass 51 therein and is attached to the lower end portion of the lens holder 25. As illustrated in FIGS. 12, 13, 14, and 15, the cover glass holder 52 includes a holding plate 53, an attachment ring 54, and a support ring 55.

As illustrated in FIGS. 13, 14, and 15, the holding plate 53 is of an integral structure including an annular member 532 of a uniform thickness having a step 531 on its inner circumferential surface that fits with the step 513 of the cover glass 51 and an outer annular member 533 joined to an outer edge of the annular member 532 and smaller in thickness than the annular member 532. The annular member 532 accommodates the cover glass 51 therein that is placed in the annular member 532 with the steps 513 and 531 engaging each other.

The outer annular member 533 has an outside diameter larger than the inside diameter of the lower end portion of the lens holder 25 and smaller than the outside diameter of the lower end portion of the lens holder 25. The annular member 532 and the outer annular member 533 of the holding plate 53 mounted on the lens holder 25 have respective axial end faces lying flush with each other and facing the condensing lens 24 and other respective axial end faces facing the holding unit 10 and axially offset from each other, providing a step 534 therebetween. Specifically, the step 534 is defined by the other axial end face of the outer annular member 533 that is axially spaced from the other axial end face of the annular member 532.

When the step 531 of the holding plate 53 on the inner circumferential surface thereof fits with the step 513 of the cover glass 51, the end face, facing the condensing lens 24, of the holding plate 53 mounted on the lens holder 25 lies flush with the end face, facing the condensing lens 24, of the cover glass 51. The cover glass 51 is accommodated in the annular member 532 of the holding plate 53 and fixed to the inner circumferential surface of the annular member 532 by an adhesive or the like.

As illustrated in FIGS. 13, 14, and 15, the attachment ring 54 is of an integral structure including an annular member 542 having on an inner circumferential surface a step 541 that fits with the step 534 of the holding plate 53 and a hollow cylindrical member 543 joined to an outer edge of the annular member 542. The annular member 542 accommodates the holding plate 53 therein that is placed in the annular member 542 with the steps 534 and 541 engaging each other.

The hollow cylindrical member 543 has an inside diameter equal to the outside diameter of the lower end portion of the lens holder 25. When the step 541 of the attachment ring 54 on the inner circumferential surface thereof fits with the step 534 of the holding plate 53 accommodated in the annular member 542, the end face, facing the condensing lens 24, of the annular member 542 mounted on the lens holder 25 lies flush with the end face, facing the condensing lens 24, of the holding plate 53.

As illustrated in FIGS. 13, 14, and 15, the support ring 55 is of an integral structure including an annular member 551 of a uniform thickness in which the circular plate 511 of the cover glass 51 is placed and a hollow cylindrical member 552 joined to an outer edge of the annular member 551. The annular member 551 has an inside diameter larger than the outside diameter of the circular plate 511 of the cover glass 51. The hollow cylindrical member 552 has an inside diameter equal to the outside diameter of the annular member 542 of the attachment ring 54.

The support ring 55 is attached to the holding plate 53 and the attachment ring 54 with the annular member 542 of the attachment ring 54 being sandwiched between the outer annular member 533 of the holding plate 53 and the annular member 551 of the support ring 55 and with the annular member 542 of the attachment ring 54 being placed in the hollow cylindrical member 552. After the support ring 55 has been mounted on the lens holder 25, the support ring 55 is fixed to the holding plate 53 by screws 56 that are inserted through holes 554 defined in the annular member 551 and opening at a surface 553 of the annular member 551 that faces the holding unit 10 and threaded into respective internally threaded holes 535 defined in the annular member 532 of the holding plate 53 in alignment with the holes 554.

The cover assembly 50 is assembled as follows. The cover glass 51 is fixed to the inner circumferential surface of the annular member 532 of the holding plate 53. The annular member 542 of the attachment ring 54 is sandwiched between the outer annular member 533 of the holding plate 53 and the annular member 551 of the support ring 55. The circular plate 511 of the cover glass 51 is accommodated in the annular member 551 of the support ring 55. The annular member 542 of the attachment ring 54 is placed in the hollow cylindrical member 552 of the support ring 55. The holding plate 53 and the support ring 55 are fixed to each other by the screws 56 inserted through the holes 554 and threaded into the internally threaded holes 535.

When the cover glass 51, the holding plate 53, the attachment ring 54, and the support ring 55 are put together, completing the cover assembly 50, the cover glass 51, the holding plate 53, the attachment ring 54, and the support ring 55 are positioned coaxially with each other. In the cover assembly 50 thus completed, the attachment ring 54 is rotatable about a central axis 544 relatively to the cover glass 51, the holding plate 53, and the support ring 55.

The central axis 544 about which the attachment ring 54 is rotatable relatively to the cover glass 51, the holding plate 53, and the support ring 55 extends through their centers, and lies eccentrically or off-center from and parallel to the optical axis 211 of the laser beam 21 transmitted through the cover glass 51 and the condensing lens 24. In other words, the central axis 544 about which the attachment ring 54 is rotatable relatively to the cover glass 51, the holding plate 53, and the support ring 55 is radially spaced from the optical axis 211 by the predetermined distance 514.

As illustrated in FIGS. 7, 8, and 10, the support ring 55 has a plurality of (eight in the present embodiment) gas guide grooves 57 defined in the surface 553 of the annular member 551. The gas guide grooves 57 are defined as elongate concavities in the surface 553 and extend straight radially from an outer edge of the support ring 55 toward the circular plate 511 of the cover glass 51 placed in the support ring 55. The gas guide grooves 57 are angularly spaced at equal intervals circumferentially around the annular member 551 of the support ring 55.

A gas ejection nozzle 58 is mounted on an outer circumferential surface of the lower end portion of the lens holder 25. The gas ejection nozzle 58 ejects a gas 581 (see FIG. 8) such as air along the surface of the cover glass 51 that faces the workpiece 200 held on the holding unit 10. The gas ejection nozzle 58 is supplied with the gas 581 from a gas supply source 583 via an on/off valve 582 (see FIG. 8). The gas ejection nozzle 58 ejects the supplied gas 581 through an ejection port 584 thereof into one of the gas guide grooves 57 radially inwardly along the surface 553 of the annular member 551 of the support ring 55. Specifically, the gas ejection nozzle 58 ejects the supplied gas 581 through the ejection port 584 that is aligned with either one of the gas guide grooves 57 radially with respect to the annular member 551 radially into the gas guide grooves 57 aligned with the ejection port 584.

As illustrated in FIG. 13, the cover assembly 50 includes a plunger mechanism 59 for positioning the support ring 55 with respect to the attachment ring 54 such that the ejection port 584 of the gas ejection nozzle 58 radially faces either one of the gas guide grooves 57 at the time the cover assembly 50 is mounted on the lens holder 25. As illustrated in FIG. 16, the plunger mechanism 59 includes a plurality of cavities 591 defined in a surface 555 of the annular member 551 of the support ring 55 that lies beneath the attachment ring 54, a hollow cylindrical member 592 disposed in a hole 546 defined in the attachment ring 54 and opening at a surface 545 thereof that lies over the support ring 55, a ball plunger 593 movably housed in the hollow cylindrical member 592, and a spring 594 housed in the hollow cylindrical member 592 and normally biasing the ball plunger 593 to move in a direction toward the annular member 551.

The cavities 591 are recessed from the surface 553 of the support ring 55. The cavities 591 are provided as many (eight in the present embodiment) as the number of the gas guide grooves 57 and are angularly spaced at equal intervals circumferentially around the annular member 551. The hollow cylindrical member 592 is of a hollow cylindrical shape that is closed at an end remote from the surface 545 of the attachment ring 54 and open at an end on the surface 545. The ball plunger 593 is of a spherical shape having a diameter equal to the inside diameter of the hollow cylindrical member 592. The spring 594 is positioned between the ball plunger 593 and the closed end of the hollow cylindrical member 592 that is remote from the surface 545 of the attachment ring 54, and is housed in the hollow cylindrical member 592.

When the cover assembly 50 is mounted on the lens holder 25 while the ball plunger 593 biased toward the support ring 55 by the spring 594 is engaging in either one of the cavities 591, the plunger mechanism 59 positions the support ring 55 with respect to the attachment ring 54 such that the ejection port 584 of the gas ejection nozzle 58 faces either one of the gas guide grooves 57.

The cover assembly 50 is attached to the lower end portion of the lens holder 25 while closing the opening 26 by being fixed in position by a fixing pin 60 (see FIGS. 12 and 14) and two eccentric pins 61 (also see FIGS. 12 and 14) and while the hollow cylindrical member 543 of the attachment ring 54 is overlapping the outer circumferential surface of the lower end portion of the lens holder 25. A structure by which the cover assembly 50 is fixed to the lens holder 25 will be described below.

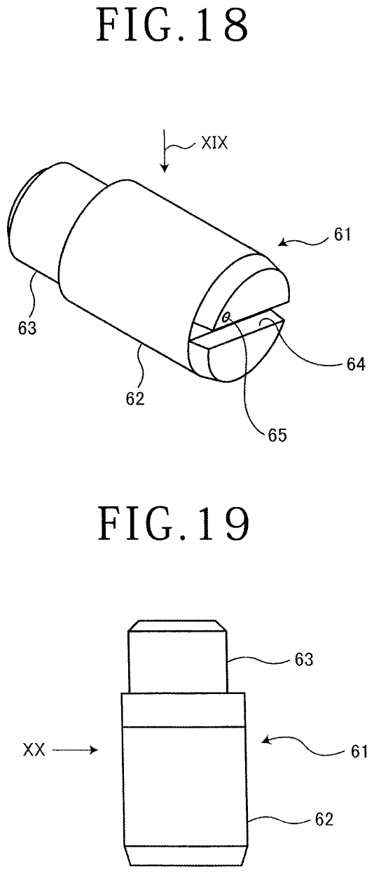

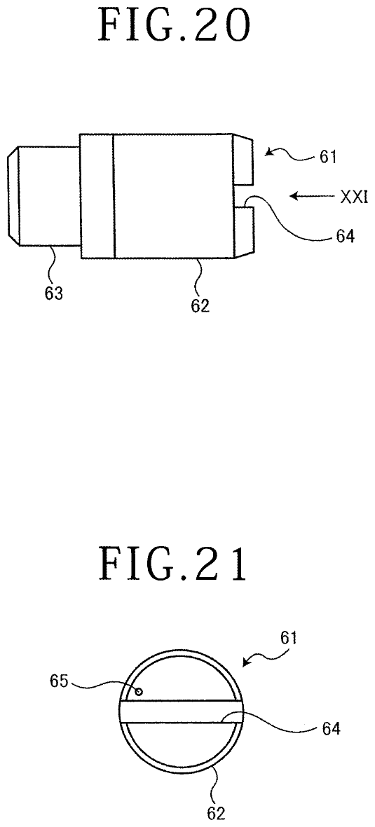

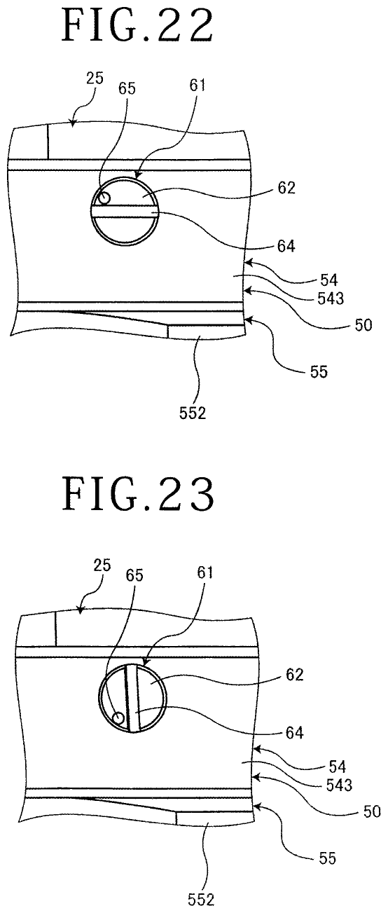

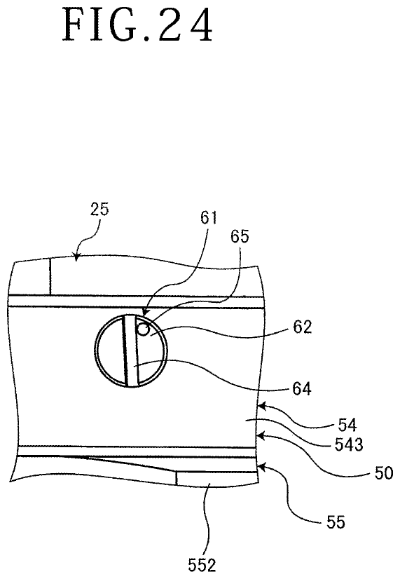

FIG. 17 illustrates in enlarged fragmentary perspective an area where the cover assembly 50 illustrated in FIG. 12 is fixed to the lower end portion of the lens holder 25. FIG. 18 illustrates in perspective one of the eccentric pins 61 by which the cover assembly 50 illustrated in FIG. 12 is fixed to the lower end portion of the lens holder 25. FIG. 19 illustrates in plan the eccentric pin 61 as viewed from direction XIX illustrated in FIG. 18. FIG. 20 illustrates in side elevation the eccentric pin 61 as viewed from direction XX illustrated in FIG. 19. FIG. 21 illustrates in front elevation the eccentric pin 61 as viewed from direction XXI illustrated in FIG. 20. FIG. 22 illustrates in front elevation the manner in which the eccentric pin 61 illustrated in FIG. 18 fixes the cover assembly 50 to the lower end portion of the lens holder 25 in a nominal position. FIG. 23 illustrates in front elevation the manner in which the eccentric pin 61 illustrated in FIG. 18 fixes the cover assembly 50 to the lower end portion of the lens holder 25 while the cover assembly 50 is positioned below the position illustrated in FIG. 22. FIG. 24 illustrates in front elevation the manner in which the eccentric pin 61 illustrated in FIG. 18 fixes the cover assembly 50 to the lower end portion of the lens holder 25 while the cover assembly 50 is positioned above the position illustrated in FIG. 22.

The fixing pin 60 is of a hollow cylindrical shape and is mounted on the hollow cylindrical member 543 of the attachment ring 54 by extending through the hollow cylindrical member 543 radially with respect to the attachment ring 54. The eccentric pins 61 are mounted on the hollow cylindrical member 543 by extending through the hollow cylindrical member 543 radially with respect to the attachment ring 54. The fixing pin 60 and the two eccentric pins 61 are angularly spaced at equal intervals circumferentially around the hollow cylindrical member 543. The fixing pin 60 and the eccentric pins 61 have their distal ends, which are directed radially inwardly with respect to the attachment ring 54, engaging in the attachment grooves 27, respectively. The cover assembly 50 is fixed to the lower end portion of the lens holder 25 by the fixing pin 60 and the eccentric pins 61 whose distal ends engaging in the respective attachment grooves 27.

As illustrated in FIGS. 18, 19, and 20, each of the eccentric pins 61 is of an integral structure including a larger-diameter portion 62 and a smaller-diameter portion 63 that are axially adjacent to each other and that have respective central axes spaced from each other, i.e., that are eccentric or off-center with respect to each other. Each of the larger-diameter portion 62 and the smaller-diameter portion 63 is of a cylindrical shape. The larger-diameter portion 62 is larger in diameter than the smaller-diameter portion 63. Each of the eccentric pins 61 extends radially through the hollow cylindrical member 543 with the smaller-diameter portion 63 being positioned in an inner circumferential portion of the hollow cylindrical member 543 and the larger-diameter portion 62 being positioned in an outer circumferential portion of the hollow cylindrical member 543. The smaller-diameter portions 63 of the eccentric pins 61 have their distal ends engaging in the corresponding attachment grooves 27. As illustrated in FIG. 21, the larger-diameter portion 62 has a slot 64 defined in an end face thereof for receiving the tip end of a tool such as a screwdriver and a mark 65 on the end face that indicates the relative position of the larger-diameter portion 62 and the smaller-diameter portion 63.

As illustrated in FIG. 17, each of the fixing pins 60 and the eccentric pins 61 is secured in position with its distal end engaging in the attachment groove 27 while being pushed toward the opposite closed end of the attachment groove 27 by a setscrew 66 that is threaded in an internally threaded hole 547 that is open in the outer circumferential surface of the hollow cylindrical member 543 of the attachment ring 54. In FIG. 17, one of the eccentric pins 61 is illustrated as a representative example whereas the fixing pin 60 is omitted from illustration, in order to illustrate the manner in which each of the fixing pin 60 and the eccentric pins 61 is secured in position by the setscrew 66.

When the tip end of the tool is inserted in the slot 64 of each of the eccentric pins 61 and turned to turn the larger-diameter portion 62 thereof about its central axis, the cover assembly 50 is fixed to the lower end portion of the lens holder 25 selectively in a nominal position illustrated in FIG. 22, a position illustrated in FIG. 23 where the cover assembly 50 is spaced a second predetermined distance downwardly from the nominal position with respect to the lens holder 25, and a position illustrated in FIG. 24 where the cover assembly 50 is spaced the second predetermined distance upwardly from the nominal position with respect to the lens holder 25. The cover assembly 50 thus fixed by the two eccentric pins 61 to the lower end portion of the lens holder 25 selectively in the nominal position illustrated in FIG. 22, the position illustrated in FIG. 23, and the position illustrated in FIG. 24 can have its orientation variable with respect to the lens holder 25. According to the present embodiment, the second predetermined distance is 0.1 mm, for example.

When the attachment ring 54 of the cover assembly 50 is attached to the lower end portion of the lens holder 25 by the fixing pin 60 and the eccentric pins 61, since the attachment ring 54 is rotatable about the central axis 544 relatively to the cover glass 51, the holding plate 53, and the support ring 55, the holding plate 53 and the support ring 55 of the cover glass holder 52 is rotatably mounted on the lens holder 25 for rotation in unison with the cover glass 51 about the central axis 544 that is spaced the distance 514 eccentrically or off-center from the optical axis 211 and that extends parallel to the optical axis 211.

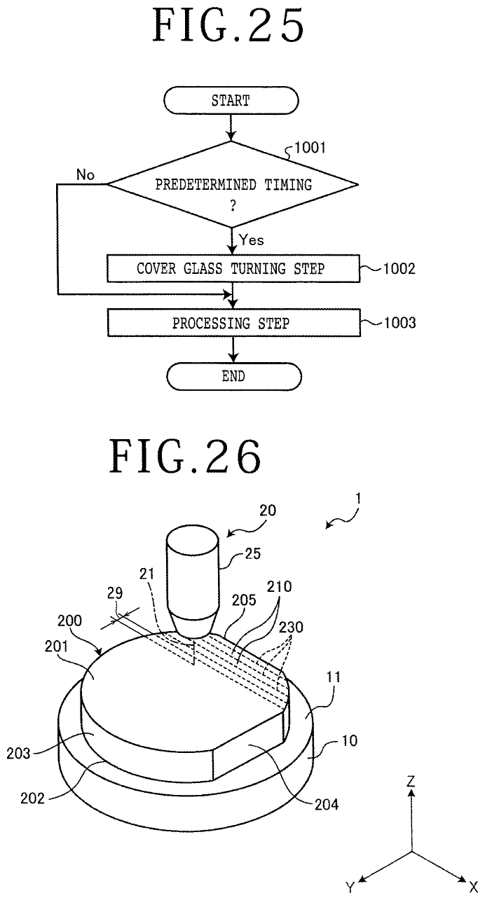

A processing method according to the present embodiment to be carried out by the laser processing apparatus 1 will be described below. FIG. 25 is a flowchart of the processing sequence of the processing method according to the present embodiment. FIG. 26 illustrates in perspective a processing step of the processing method illustrated in FIG. 25. The processing method according to the present embodiment refers to a method of performing a laser processing operation on the workpiece 200 with the laser processing apparatus 1 of the above-described arrangement. As illustrated in FIG. 25, the processing method according to the present embodiment includes cover glass turning step 1002 and processing step 1003.

In the processing method according to the present embodiment, while the laser processing apparatus 1 is not in operation, the operator or the like determines whether a predetermined timing has arrived or not (step 1001). The predetermined timing refers to a timing at which the support ring 55 of the cover assembly 50 attached to the lower end portion of the lens holder 25 is to rotate about the central axis 544 with respect to the lens holder 25. Alternatively, the predetermined timing refers to a timing at which debris is deposited on the cover glass 51 near the optical axis 211 of the laser beam 21 transmitted through the cover glass 51, tending to disrupt the processing of the workpiece 200 with the laser beam 21. Still alternatively, the predetermined timing refers to, for example, a timing after the detection of debris on the cover glass 51 or upon elapse of a predetermined period of one week or the like, for example, from a preceding cycle of the cover glass turning step 1002.

If the operator or the like decides that the predetermined timing has arrived (step 1001: Yes), then the processing sequence goes to the cover glass turning step 1002. The cover glass turning step 1002 is a step of rotating the cover glass 51 about the central axis 544 at a predetermined timing.

In the cover glass turning step 1002, the operator or the like turns the support ring 55 together with the cover glass 51 about the central axis 544 until the ball plunger 593 of the plunger mechanism 59 engages in one of the cavities 591, whereupon the support ring 55 is positioned with respect to the attachment ring 54. After the cover glass turning step 1002, the processing sequence goes to the processing step 1003. If the operator or the like decides that the predetermined timing has not arrived (step 1001: No), then the processing sequence jumps to the processing step 1003.

The processing step 1003 is a step of focusing the laser beam 21 emitted from the laser oscillator 22 with the condensing lens 24 and applying the focused laser beam 21 to the workpiece 200 held on the holding unit 10, thereby processing the workpiece 200 with the laser beam 21, after the operator or the like has decided that the predetermined timing has not arrived (step 1001: No) or after the cover glass turning step 1002 has been carried out.

According to the present embodiment, in the processing step 1003, the controller 100 of the laser processing apparatus 1 accepts and registers processing conditions etc. entered by the operator, and the second surface 202 of the workpiece 200 is placed on the holding surface 11 of the holding unit 10 that has been positioned in the loading/unloading region. Then, when the controller 100 accepts a command from the operator to start a processing operation, the controller 100 instructs the laser processing apparatus 1 to start the processing operation on the workpiece 200 and hold under suction the second surface 202 of the workpiece 200 on the holding surface 11 of the holding unit 10.

Thereafter, the controller 100 opens the on/off valve 582 to eject the gas supplied from the gas supply source 583 from the ejection port 584 of the gas ejection nozzle 58 into one of the gas guide grooves 57 along the surface 553 and the surface of the cover glass 51 that faces the workpiece 200. The controller 100 controls the moving assembly 30 to move the holding unit 10 to the processing region, controls the image capturing unit 40 to capture an image of the workpiece 200 held on the holding unit 10, and performs the alignment process based on the captured image. In the alignment process, the controller 100 directs the second orientation flat 205 parallel to the X-axis. In a first cycle of the processing step 1003, the controller 100 positions the condensing lens 24 of the laser beam applying unit 20 above an end of the workpiece 200 along the X-axis next to the second orientation flat 205.

In the processing step 1003, the controller 100 controls the laser beam applying unit 20 to cause the laser oscillator 22 to generate the pulsed laser beam 21 whose wavelength is transmittable through the workpiece 200. The controller 100 also controls the moving assembly 30 to position the focused spot of the laser beam 21 in the workpiece 200 at a depth from the first surface 201 thereof that corresponds to a thickness 222 (see FIG. 4) of a wafer 220 to be fabricated from the workpiece 200. The controller 100 then applies the laser beam 21 to the workpiece 200 while moving the laser beam applying unit 20 and the holding unit 10 relatively to each other along the X-axis.

When the workpiece 200 is irradiated with the laser beam 21, since the laser beam 21 has its wavelength transmittable through the workpiece 200 and has its focused spot positioned in the workpiece 200 at the depth from the first surface 201 thereof that corresponds to the thickness 222 of the wafer 220 to be fabricated, the laser beam 21 forms, in the workpiece 200 along the X-axis at the depth referred to above, a modified region 210 (see FIG. 26) with cracks extending from the modified region 210 along the c-plane 209. The modified region 210 refers to a region where silicon carbide (SiC) is separated into silicon (Si) and carbon (C) by an applied pulse of the laser beam 21 and a next applied pulse of the laser beam 21 is absorbed by the carbon (C), so that silicon carbide is separated into silicon and carbide in a chain reaction. When the workpiece 200 is irradiated with the laser beam 21 whose wavelength is transmittable through the workpiece 200, therefore, a peel-off layer 230 including the modified region 210 and cracks extending from the modified region 210 along the c-plane 209 is formed in the workpiece 200 along the second orientation flat 205.

The modified regions 210 represent regions where a density, a refractive index, a mechanical strength, and other physical characteristics are different from those in peripheral regions, and may be referred to as melted regions, cracked regions, dielectric breakdown regions, varied refractive index regions, or regions where those regions exist together, for example. The modified regions 210 have a lower mechanical strength etc. than the other regions in the workpiece 200.

In the processing step 1003, when the peel-off layer 230 has been formed in the workpiece 200 fully along the second orientation flat 205, the controller 100 controls the laser beam applying unit 20 to temporarily stops applying the laser beam 21 to the workpiece 200, and then controls the moving assembly 30 to move, i.e., indexing-feeds, the laser beam applying unit 20 and the holding unit 10 relatively to each other along the Y-axis by a predetermined distance 29 (see FIG. 26).

After the moving assembly 30 has indexing-fed the laser beam applying unit 20 and the holding unit 10 relatively to each other along the Y-axis, the controller 100 positions the focused spot of the laser beam 21 in the workpiece 100 at the depth referred to above, and applies the laser beam 21 to the workpiece 200 while moving the laser beam applying unit 20 and the holding unit 10 relatively to each other along the X-axis, thereby forming another peel-off layer 230 in the workpiece 200 along the X-axis.

In the processing step 1003, the controller 100 alternately applies the laser beam 21 to the workpiece 200 while moving the laser beam applying unit 20 and the holding unit 10 relatively to each other along the X-axis and indexing-feeds the laser beam applying unit 20 and the holding unit 10 relatively to each other along the Y-axis in repeated cycles, forming successive peel-off layers 230 in the workpiece 200. When the peel-off layers 230 have been formed in the workpiece 200 entirely below the first surface 201 thereof, the laser processing apparatus 1 finishes the processing step 1003, i.e., the processing operation on the workpiece 200. After the peel-off layers 230 have been formed in the workpiece 200 entirely below the first surface 201, the wafer 220 (see FIG. 4) that includes the first surface 201 is peeled off from the workpiece 200 along the peel-off layers 230 that act as peel-off initiating points.

The laser processing apparatus 1 and the processing method according to the embodiment described above offer the following advantages. The cover glass 51 that is rotatable about the central axis 544 spaced eccentrically or off-center from the optical axis 211 of the condensing lens 24 and the laser beam 21 is mounted on the lens holder 25 in covering relation to the opening 26 and hence the condensing lens 24. Therefore, inasmuch as debris produced when the workpiece 200 is processed by the laser beam 21 collides with and is deposited on the cover glass 51, the debris is prevented from being deposited on the condensing lens 24 and hence from causing damage to the condensing lens 24.

Furthermore, debris produced when the workpiece 200 is processed by the laser beam 21 is deposited on the cover glass 51 at a position aligned with the optical axis 211 and spaced from the central axis 544 by the predetermined distance 514, tending to cause damage to the cover glass 51 at the position aligned with the optical axis 211. When the debris has been deposited on the cover glass 51 at the position aligned with the optical axis 211 and/or caused damage to the cover glass 51 at the position, the operator or the like turns the support ring 55 about the central axis 544, displacing the debris and/or the damage away from the optical axis 211. Therefore, the laser beam 21 is not prevented from passing through the cover glass 51 by the debris on and/or the damage to the cover glass 51.

As a result, the laser processing apparatus 1 and the processing method according to the present embodiment are advantages in that the laser processing operation can be continued without removing debris deposited on the cover glass 51 and even if the cover glass 51 is damaged by debris by turning the support ring 55 in unison with the cover glass 51 about the central axis 544.

The present invention is not limited to the above embodiment. Various changes and modifications may be made therein without departing from the scope of the invention. According to the present invention, the workpiece 200 may include a wafer such as a semiconductor wafer shaped as a circular plate, or an optical device wafer that includes a substrate made of, for example, silicon (Si), sapphire (Al₂O₃), gallium arsenide (GaAs), silicon carbide (SiC), or lithium tantalate (LiTaO₃), or the like. If the workpiece 200 includes such a wafer, then a plurality of intersecting projected dicing lines are established on a face side of the wafer to demarcate a plurality of areas on the face side, and a plurality of devices are constructed respectively in the demarcated areas.

The devices may be integrated circuits (ICs), large-scale-integration (LSI) circuits, or the like, image sensors such as CCDs, or CMOS image sensors, or memories, i.e., semiconductor storage devices.

According to the present invention, furthermore, the laser processing apparatus 1 may include a processing apparatus for applying a laser beam having a wavelength absorbable by the workpiece 200 to perform an ablating operation of the workpiece 200.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
a holding unit for holding a workpiece thereon;
a laser oscillator for emitting a laser beam to be applied to the workpiece held on the holding unit;
a condensing lens for focusing the laser beam emitted from the laser oscillator to the workpiece;
a lens holder housing the condensing lens therein;
a cover glass disposed between the condensing lens and the holding unit for protecting the condensing lens from foreign matter produced from the workpiece when the workpiece is processed by the laser beam; and
a cover glass holder housing the cover glass and attached to the lens holder, wherein
the cover glass holder is rotatably mounted on the lens holder for rotation about a central axis spaced eccentrically from an optical axis of the condensing lens and parallel to the optical axis.

2. The laser processing apparatus according to claim 1, further comprising:
a gas ejection nozzle for ejecting a gas along a surface of the cover glass that faces the workpiece held on the holding unit.

3. A processing method of processing a workpiece with a laser processing apparatus including a holding unit for holding a workpiece thereon, a laser oscillator for emitting a laser beam to be applied to the workpiece held on the holding unit, a condensing lens for focusing the laser beam emitted from the laser oscillator to the workpiece, a lens holder housing the condensing lens therein, a cover glass disposed between the condensing lens and the holding unit for protecting the condensing lens from foreign matter produced from the workpiece when the workpiece is processed by the laser beam, and a cover glass holder housing the cover glass and attached to the lens holder, the processing method comprising:
a cover glass turning step of turning the cover glass about a central axis thereof at a predetermined timing; and
after the cover glass turning step, a processing step of focusing the laser beam emitted from the laser oscillator with the focusing lens and applying the focused laser beam to the workpiece held on the holding unit, thereby processing the workpiece with the laser beam.
